(19) United States
(12) Patent Application Publication
(10) Pub. No.: US 2024/0351406 A1
(43) Pub. Date: Oct. 24, 2024

(54) WINDOW SCREEN FOR AUTOMOBILE

(71) Applicants: Yoshio KUMANO, Matsuyama-shi, Ehime (JP); NIPPON PISTON RING CO., LTD., Saitama-shi, Saitama (JP)

(72) Inventors: Hiroshi TAKIGUCHI, Saitama-shi, Saitama (JP); Motofumi KAWAI, Saitama-shi, Saitama (JP); Makoto SAGAWA, Saitama-shi, Saitama (JP); Yoshio KUMANO, Matsuyama-shi, Ehime (JP)

(73) Assignees: Yoshio KUMANO, Matsuyama-shi, Ehime (JP); NIPPON PISTON RING CO., LTD., Saitama-shi, Saitama (JP)

(21) Appl. No.: 18/683,575

(22) PCT Filed: Aug. 30, 2022
(86) PCT No.: PCT/JP2022/032587

§ 371 Date: Feb. 14, 2024

(30) Foreign Application Priority Data
Sep. 27, 2021 (JP) 2021-156272

(51) Int. Cl. B60J 1/20

(52) U.S. Cl. CPC B60J 1/20

(57) ABSTRACT

Automobile window screen allowing the automobile to be driven with the screen attached outside an automobile window frame and capable of suppressing floating or wind noise even under pressure while driving, having a frame body that substantially conforms to the window frame, the frame body including: a rail member constituting a straight portion; a corner member coupled to the rail member; and a fixing stay that is attached to the rail member with an attachment member and that is to be inserted between the window frame and glass, wherein the rail member has a thickness 10 mm or more and 20 mm or less and a width of 20 mm or more and 50 mm or less, and the attachment member is attached in plurality with an interval of 50 mm or more and 250 mm or less on one of the rail member.

### TECHNICAL FIELD

The present invention relates to a window screen for automobile that is to be attached outside a window frame of an automobile.

### BACKGROUND ART

Currently, overwhelmed by the viral infectious disease pandemic, not to mention that social activities are voluntarily restricted, personal activities are also being constrained. For example, in business environment, remote work in which workers work from home is introduced, and for travelling, the use of automobiles is increasing in order to avoid public transportation. In such a situation, as a place for remote work, chances are increasing for using a seating area of an automobile as a private workroom, while moving (driving) and stopping may sometimes be repeated. Chances are also increasing for using automobiles for taking a break, a nap, sleeping in a car, or the like, and when a person stays in the seating area for a relatively long time for such purposes, air conditioning management or ventilation of the seating area is indispensable.

However, air conditioning relying on an air conditioner of the automobile consumes a large amount of electricity; using the air conditioner in an idling-stopped state gives rise to a particularly large consumption of electricity, and in the case of an electric automobile in particular, a travelable distance of the vehicle may even be affected. Furthermore, when a window is kept open for ventilation, a problem arises in that bugs such as mosquitoes enter the seating area.

Therefore, various window screens for automobile have been known, which are able to bring fresh air into the seating area and prevent bugs such as mosquitoes or flies from entering. For example, Patent Literature 1 describes an invention of a window screen for automobile that is compliant to external protrusion regulations, which are parts of road transport vehicle safety standards for automobile, and that allows the automobile to be driven with the window screen attached to the outside of a window frame of the automobile. As other configurations, many simplified removable window screens are available on market, which do not allow the automobile to be driven while the window is left open with the window screen attached.

### CITATION LIST

### Patent Literature

Patent Literature 1: Japanese Utility Model Registration No. 3170981

### SUMMARY OF INVENTION

### Technical Problem

Although the window screen for automobile described in Patent Literature 1 is a window screen structured to resist separation due to vibration when the automobile is driven, floating or rattling of the window screen may be caused by a wind pressure when the automobile speed increases. Furthermore, since the window screen is attached to a side surface of the automobile in a protruding manner, a wind noise may be caused by a wind pressure.

Therefore, an object of the present invention, which has been made in view of the above circumstances, is to provide a window screen for automobile that allows the automobile to be driven with the window screen remaining attached outside a window frame of an automobile and that is capable of suppressing floating or occurrence of a wind noise even under a wind pressure while the automobile is being driven.

### Solution to Problem

The present invention has been made to attain the object described above and has features described below.

A window screen for automobile according to an embodiment is a window screen for automobile that can be attached outside a window frame of an automobile, the window screen for automobile having a frame body that substantially conforms to the window frame, the frame body including: at least one rail member constituting a straight portion; a corner member coupled to the at least one rail member; and a fixing stay that is attached to the at least one rail member with an attachment member and that is to be inserted between the window frame and a window glass, wherein the at least one rail member has a thickness dimension of 10 mm or more and 20 mm or less and a width dimension of 20 mm or more and 50 mm or less, the at least one rail member is provided with a curved surface that has a radius of 2.5 mm or more and 10 mm or less in an outside corner and is provided with a curved surface that has a radius of 0.1 mm or more and 1.5 mm or less in an inside corner, and the attachment member for attaching the fixing stay is attached in plurality with an interval of 50 mm or more and 250 mm or less on one of the at least one rail member.

In the window screen for automobile according to the embodiment, preferably, the rail member located on a bottom is provided with a drain gap.

In the window screen for automobile according to the embodiment, preferably, the corner member is provided with a sealing and cushioning material.

In the window screen for automobile according to the embodiment, preferably, the at least one rail member is provided with mohair.

In the window screen for automobile according to the embodiment, preferably, the fixing stay is divided and arranged in a plurality of fixing stays.

In the window screen for automobile according to the embodiment, preferably, a cushioning material is attached to the fixing stay.

In the window screen for automobile according to the embodiment, preferably, the fixing stay is provided with a drain through-portion.

### Advantageous Effects of Invention

According to the window screen for automobile of the present invention, it is possible to drive the automobile with the window screen attached to the outside of the window frame and to suppress floating of the window screen or occurrence of a wind noise caused by a wind pressure while the automobile is being driven.

### BRIEF DESCRIPTION OF DRAWINGS

FIG. 1 is a perspective view illustrating a window screen according to the embodiment of the invention.

FIG. 2 is a sectional view illustrating a rail member according to the embodiment of the invention.

FIG. 3 is a sectional view illustrating a frame body according to the embodiment of the invention.

FIG. 4 is a perspective view illustrating a frame body according to the embodiment of the invention and an example of a drain gap located on the bottom when attached.

FIG. 5 is an exploded perspective view illustrating a coupling portion between the rail member and a corner member according to the embodiment of the invention and illustrating a side facing a side surface of the automobile when attached.

FIG. 6 is an exploded perspective view illustrating a coupling portion between rail member and the corner member according to the embodiment of the invention and illustrating an outside when attached.

FIG. 7 is a perspective view illustrating a fixing stay according to the embodiment of the invention, which is a variation in which fixation is made by two or more sets of attachment members.

FIG. 8 illustrates the fixing stay according to the embodiment of the invention and is an enlarged perspective view of zone A in FIG. 7.

FIG. 9 is a reference view illustrating how the window screen according to the embodiment of the invention is to be attached to a window frame of the automobile.

FIG. 10 is a reference view illustrating a test method of a wind pressure test that simulates a state in which the window screen according to the embodiment of the invention is attached to an automobile.

FIG. 11 is a list illustrating test results of the wind pressure simulation test.

FIG. 12 is a graph illustrating a relation between a thickness B and an outer radius R.

### DESCRIPTION OF EMBODIMENT

A suitable embodiment for carrying out the present invention will now be described with reference to drawings. The embodiment described below is not intended to limit the invention according to claims, or all combinations of features described in the embodiment are not necessarily essential to solution of the invention.

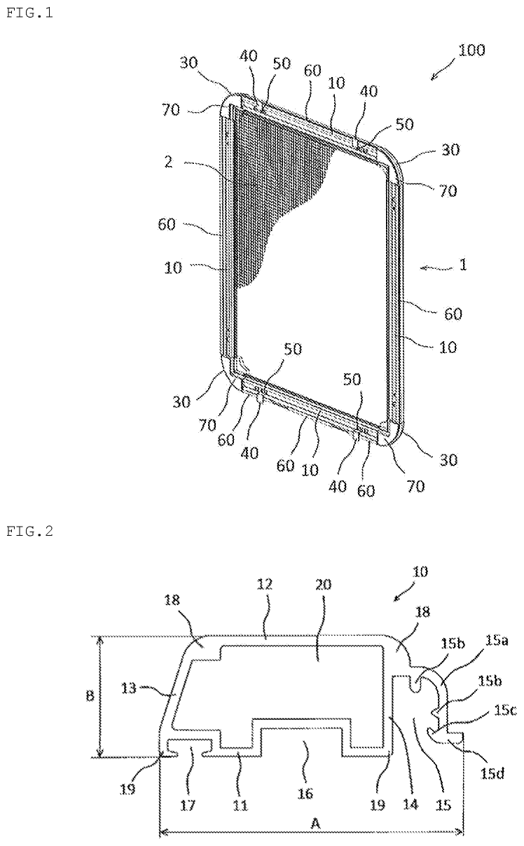

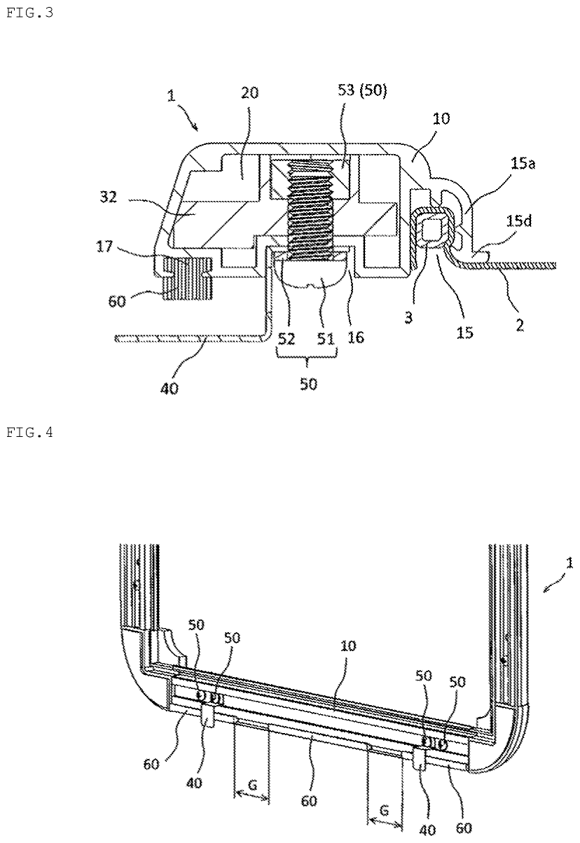

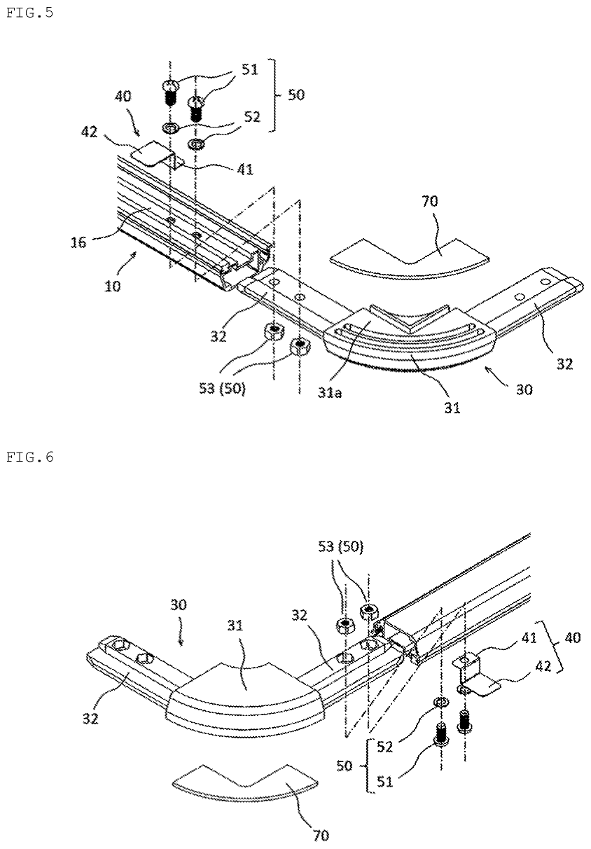

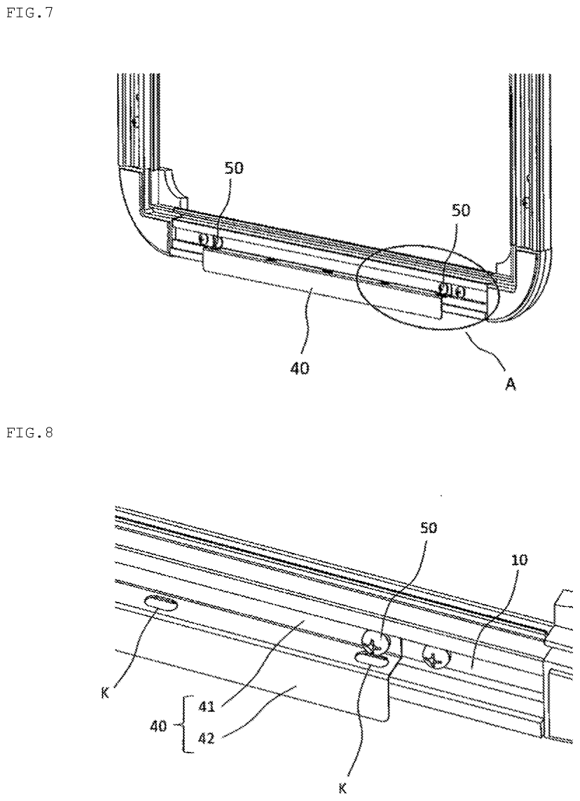

FIG. 1 is a perspective view illustrating a window screen according to the embodiment of the invention, FIG. 2 is a sectional view illustrating a rail member according to the embodiment of the invention, FIG. 3 is a sectional view illustrating a frame body according to the embodiment of the invention, FIG. 4 is a perspective view illustrating a frame body according to the embodiment of the invention and an example of a drain gap located on the bottom when attached, FIG. 5 is an exploded perspective view illustrating a coupling portion between the rail member and a corner member according to the embodiment of the invention and illustrating a side facing a side surface of the automobile when attached, FIG. 6 is an exploded perspective view illustrating a coupling portion between rail member and the corner member according to the embodiment of the invention and illustrating an outside when attached, FIG. 7 is a perspective view illustrating a fixing stay according to the embodiment of the invention, which is a variation in which fixation is made by two or more sets of attachment members, and FIG. 8 is an enlarged perspective view of zone A in FIG. 7.

### Parts Configuration of Window Screen for Automobile

As illustrated in FIG. 1, a window screen 100 according to the embodiment is formed from a frame body 1 in a shape that substantially conforms to a window frame of an automobile, and a net part 2 attached to the frame body 1.

The frame body 1 is formed from a plurality of rail members 10 each constituting a straight portion, a plurality of corner members 30 that are each located on a corner of the frame body 1 and coupled to the rail member 10, and a plurality of fixing stays 40 attached to the rail member 10.

As illustrated in FIG. 2, the rail member 10 according to the embodiment has a sectional shape including a hollow portion 20 inside. Surfaces constituting a section of the rail member 10 are formed from a bottom surface 11, which is a surface that is to face the window frame in a state in which the window screen 100 is attached to a window frame of an automobile (hereinafter referred to as an attached state), a front surface 12, which is a surface that is opposite to the bottom surface 11 and located on the outside in the attached state, an outer side surface 13, which is a surface that connects the bottom surface 11 and the front surface 12 and is located on a circumference of the frame body 1, and an inner side surface 14, which is a surface that connects the bottom surface 11 and the front surface 12 and is located on an inside of the frame body 1. Furthermore, an outside corner 18, which is a corner where the front surface 12 and the outer side surface 13 or the inner side surface 14 are connected, and an inside corner 19, which is a corner where the bottom surface 11 and the outer side surface 13 or the inner side surface 14 are connected, include curved surfaces respectively formed thereon.

A rubber pressure piece 15a is formed on the inner side surface 14 and a first groove portion 15 is formed so as to open on the bottom surface 11 side. As illustrated in FIG. 3, the first groove portion 15 is a groove into which the net part 2 and a pressure rubber 3 for fixing the net part 2 are inserted and which is formed to have a width smaller than an outer diameter of the pressure rubber 3. Accordingly, by pressing the net part 2 and the pressure rubber 3 into the first groove portion 15, the net part 2 can be pressed and fixed against an inner surface of the first groove portion 15 by means of a repulsive force of the compressed pressure rubber 3. Here, as illustrated in FIG. 2, the inner surface of the first groove portion 15 may be provided with a protruding part 15b to increase a contact pressure by the repulsive force of the pressure rubber 3 such that the net part 2 is less likely to detach from. Furthermore, the rubber pressure piece 15a may be provided with an inward-facing ridge 15c on an end portion to have a shape such that the pressure rubber 3 is prevented from falling off.

As illustrated in FIG. 3, the net part 2 is attached such that it passes between the end portion of the rubber pressure piece 15a and a window frame of an automobile. Accordingly, the end portion of the rubber pressure piece 15a is formed such that, in the attached state of the window screen 100, there can be a space large enough for the net part 2 to pass between the end portion and a window frame of an automobile. Furthermore, since the net part 2 is attached so as to be in contact with the end portion of the rubber pressure piece 15a, the end portion of the rubber pressure piece 15a is preferably shaped such that no local load is applied to the net part 2. For example, as illustrated in FIG. 3, preferably, the end portion of the rubber pressure piece 15a is provided with a support piece 15d, which has a curved surface formed in a corner to be able to increase a contact area of the corner.

In the embodiment, although the rubber pressure piece 15a is formed such that a step is created between the rubber pressure piece 15a and the front surface 12 as illustrated in FIG. 2, the shape of the rubber pressure piece 15a is not limited thereto, and may be in an integral shape with the outside corner 18 without a step between the rubber pressure piece 15a and the front surface 12.

As illustrated in FIG. 2 and FIG. 3, a second groove portion 16 for attaching the fixing stay 40 is formed on the bottom surface 11 at substantially a center portion in a width direction, and a third groove portion 17 for attaching mohair 60, which will be described later, is formed on the bottom surface 11 at a location to be on a circumference side of the frame body 1 in the attached state of the window screen 100.

The hollow portion 20 of the rail member 10 is formed in such a size that an insertion part 32 of a corner member 30, which will be described later, can be inserted.

For the sectional shape of the rail member 10 according to the embodiment, a width A and a thickness B illustrated in FIG. 2 are determined by a wind pressure simulation test, which will be described later. Specifically, the width A is made 20 mm or more and 50 mm or less and the thickness B is made 10 mm or more and 20 mm or less.

The radius of the curved surface formed in the outside corner 18 (hereinafter referred to as an outer radius R) is limited by the dimension of the thickness B and is determined within an inside the frame line in the graph illustrated in FIG. 12. Specifically, when the thickness B is 10 mm, the outer radius R is determined in the range of 2.5 mm or more and 5 mm or less and when the thickness B is 20 mm, the outer radius R is determined in the range of 2.5 mm or more and 10 mm or less. When the outer radius R is 2.5 mm or less, external protrusion regulations, which are parts of road transport vehicle safety standards for automobile, are not satisfied, and when the radius is larger than the range of the frame line illustrated in FIG. 12, it will be difficult to secure a smooth surface with a sufficient length in the outer side surface 13 and the inner side surface 14, which may lead to a decrease in the rigidity of the rail member 10.

The radius of the curved surface formed in the inside corner 19 (hereinafter referred to as an inner radius R) is made 0.1 mm or more such that areas of a vehicle body may not be damaged when the window screen 100 is to be attached to the window frame. Furthermore, when the inner radius R is larger, there is a risk that rainwater is brought into a space between a vehicle body and the rail member 10, and thus the inner radius R is preferably 1.5 mm or less. Forming such a curved surface in the inside corner 19 can also help prevent chipping of the inside corner 19.

As a material for the rail member 10 having a sectional shape as described above, light metal such as an aluminum alloy, for example, A6063 (T5) is preferably used. Here, the material for the rail member 10 is not limited thereto, and may be a resin material that has a strength equivalent to A6063 (T5).

The length of the rail member 10 is set as necessary to fit the size of a window frame of an automobile to which it is attached.

The mohair 60 is a member formed of a bundle of filaments made of synthetic fibers, and is attached to the third groove portion 17 of the rail member 10, so that in the attached state of the window screen 100, it closes a space between the rail member 10 and a vehicle body to prevent rainwater, bugs, or the like from entering the inside of the frame body 1. To the rail members 10 located on the top, right, and left sides in the attached state of the window screen 100, the mohair 60 is attached over the entire length of the rail member 10. The rail member 10 located on the bottom in the attached state of the window screen 100 may be provided with a location where no mohair 60 is attached such that a gap (hereinafter referred to as drain gap G) is partially formed as illustrated in FIG. 4. Providing the drain gap G on the bottom of the window screen 100 in this way leaves a space between the rail member 10 and a vehicle body, which makes it possible to drain rainwater entered the inside of the frame body 1. In the description above, although the drain gap G is formed due to absence of the mohair 60, it is not limited thereto, and the drain gap G may be formed by replacing the mohair 60 with short-haired mohair.

As illustrated in FIG. 5, the corner member 30 is a member that is coupled to the rail member 10 and made of resin, and formed from a corner part 31 that determines an angle of the corner of the frame body 1, and an insertion part 32 inserted into the hollow portion 20 of the rail member 10. As illustrated in FIG. 5, the corner member 30 is coupled to the rail member 10 with an attachment member 50, which is a set of a screw 51, a spring washer 52 and a nut 53.

In the corner part 31, a coupling angle of the rail members 10 is set as necessary to fit the shape of a window frame of an automobile to which it is attached. For example, the setting is made such that the shape of the frame body 1 is substantially a trapezoid or substantially a parallelogram by combining a corner member 30 with a corner part 31 that creates an acute angle between the rail members 10 that are to be connected, with a corner member 30 with a corner part 31 that creates an obtuse angle.

As describe above, since the frame body 1 is formed from the rail member 10 that can be set in its length as necessary, and the corner member 30 that can be set in the coupling angle, it is easy to create variations to fit a window frame of an automobile to which it is attached. FIG. 1 illustrates, as an example, the frame body 1 using such a corner member 30 that creates a right angle between the rail members 10 that are to be connected.

As illustrated in FIG. 5, the corner part 31 includes a sealing and cushioning material 70 made of a material such as rubber attached on a corner part bottom surface 31a that faces a window frame in the attached state of the window screen 100 to prevent damage to areas of a vehicle body even when the corner part 31 comes into connect with the window frame.

The sealing and cushioning material 70 has a shape analogous to the corner part bottom surface 31a, and it is preferable when the sealing and cushioning material 70 is formed such that its footprint area is 50% or more and 95% or less with respect to the area of the corner part bottom surface 31a. When the footprint area of the sealing and cushioning material 70 is 50% or less with respect to the area of the corner part bottom surface 31a, depending on the design of the curved surface or the like provided on a side surface of a vehicle body, the sealing and cushioning material 70 may fail to contact the vehicle body side surface, so that a space may be created between the vehicle body and the corner part bottom surface 31a. Furthermore, when the footprint area of the sealing and cushioning material 70 is 95% or more with respect to the area of the corner part bottom surface 31a, the sealing and cushioning material 70 may stick out of the profile of the corner part bottom surface 31a, leading to a problem with external appearance.

As illustrated in FIG. 6, recesses for embedding a nut 53 that is to be threadedly engaged with a screw 51 for coupling to the rail member 10, and a nut 53 that is to be threadedly engaged with a screw 51 for attaching the fixing stay 40 are formed in the insertion part 32. Here, the recess is shaped to support a width across flat of the nut 53, so that when the screw 51 is fastened, it is possible to prevent the nut 53 from rotating together. Furthermore, it is preferable when a leading end portion of the insertion part 32 is provided with a chamfer or a curved surface such that it can be smoothly inserted into the hollow portion 20 of the rail member 10.

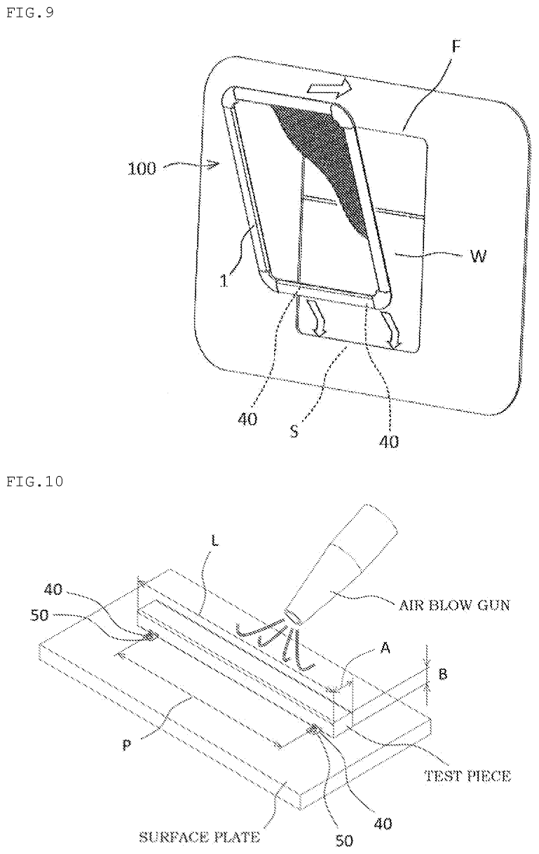

As illustrated in FIG. 5, the fixing stay 40 is a plate-like component on which a step is formed, and has a fixture end portion 41 provided with a through-hole through which the screw 51 is passed, and a leading end portion 42 that can be inserted between a window frame F of an automobile and a window glass W in the attached state of the window screen 100 as illustrated in FIG. 9. Here, the leading end portion 42 may include a cushioning material attached thereto in order to avoid damage to the window frame F or the window glass W.

As illustrated in FIG. 1, the fixing stays 40 are fixed on the rail members 10 located on opposite sides of the frame body 1 (the rail members 10 located on the top and bottom in the embodiment), in at least two positions for each one of the rail members 10. The interval between attachment portions of a plurality of fixing stays 40 attached to one of the rail members 10 is determined by a wind pressure simulation test, which will be described later, and specifically, the fixing stays 40 are attached with an interval between attachment members 50 in the range of 50 mm or more and 250 mm or less. For the fixing stay 40 attached to the rail member 10, as illustrated in FIG. 1, a plurality of narrow fixing stays 40, which are each fixed by a set of attachment members 50, may be divided and attached to one of the rail members 10, or as illustrated in FIG. 7, only one wide fixing stay 40 fixed by two or more sets of attachment members 50 may be attached to one of the rail members 10. Even when the wide fixing stay 40 fixed by two or more sets of attachment members 50 as illustrated in FIG. 7 is used, it is attached with the interval between the attachment members 50 in the range of 50 mm or more and 250 mm or less in the same way as when a plurality of narrow fixing stays 40, which are divided and attached, are used.

As illustrated in FIG. 8, the fixing stay 40 may be provided with a drain through-portion K in a surface that is a step portion joining the fixture end portion 41 and the leading end portion 42 and that is in parallel to the ground in an attached state of the window screen 100 with an automobile. Providing the drain through-portion K in the step portion of the fixing stay 40 in this way makes it possible to prevent rainwater from accumulating on a surface in parallel to the ground even with the wide fixing stay 40. Although the shape of the drain through-portion K is determined depending on the shape of the step portion of the fixing stay 40, a long hole that has a major dimension of 4 mm or more and 8 mm or less and a minor dimension of 2.5 mm or more and 6.5 mm or less is preferable for appropriately draining rainwater.

Furthermore, in the embodiment, it is preferable when the drain through-portion K is provided in a position corresponding to the bottom of the attachment member 50.

The net part 2 is required to have a certain strength, durability, and heat resistance such that an automobile can be driven with the window screen 100 remaining attached to the automobile without damage. Accordingly, it is preferable to use glass fibers, stainless steel, or other materials that have a strength equivalent to those materials as the material for the net part 2.

### To Attach to Automobile Window Frame

Next, how the window screen 100 is to be attached to a window frame of an automobile will be described. FIG. 9 is a reference view illustrating how the window screen 100 is to be attached to a window frame of the automobile.

To attach the window screen 100, first, as illustrated in FIG. 9, the leading end portion 42 of the fixing stay 40 located on the bottom is inserted into a space S between the bottom of the window frame F and the window glass W. At this time, the fixing stay 40 on the top is kept removed.

Next, the frame body 1 is pressed against the window frame F in an overlapping manner, and the fixing stay 40 on the top is attached with the attachment member 50 from the inside of the automobile. At this time, attachment is done such that the leading end portion 42 of the fixing stay 40 on the top is located in the space S between the top of the window frame F and the window glass W. Since the fixing stay 40 is fixed with the attachment member 50 from the inside of the window frame F, the window screen 100, which is attached from the inside of the automobile, cannot be removed from the outside of the automobile, so that damage caused by the window screen 100 being stolen or tampered can be prevented.

The step portion of the fixing stay 40 has a shape with the number of steps, step height, or the like set as necessary depending on the thickness of the window frame F of the automobile to which it is attached, so that the mohair 60 comes into close contact with the window frame F in the state in which the window screen 100 is fixed to the window frame F and it is possible to prevent rainwater from entering the inside of the frame body 1.

Although description has been made in the embodiment as to when the window screen 100 is to be attached with the fixing stay 40 on the top being removed in advance, how the window screen 100 is to be attached is not limited thereto, and the through-hole provided on the fixture end portion 41 of the fixing stay 40 through which the screw 51 is passed may be provided as a long hole and attachment may be done by sliding the fixing stay 40 up and down.

### Wind Pressure Simulation Test

Next, the present invention will be described in detail with reference to test results of a wind pressure simulation test that reproduces a state in which the window screen 100 according to the embodiment is attached to an automobile and the automobile is driven.

FIG. 10 is a reference view illustrating a test method of a wind pressure test that simulates a state in which the window screen 100 is attached to an automobile.

As illustrated in FIG. 10, a wind pressure simulation test is conducted by attaching a test piece having a length L of 300 mm that simulates the rail member 10 to a surface plate with the fixing stays 40 and loading the test piece with an air flow (wind pressure) equivalent to a vehicle speed by using an air blow gun. The air flow (wind pressure) generated by the air blow gun was adjusted by adjusting the air pressure and the distance between the air blow gun and the test piece to simulate as if the automobile is driven at 100 km/h. Under such conditions, a width A and a thickness B of the test piece and an attachment interval P between the attachment members 50 fixing the fixing stays 40 are varied, and after the test piece was attached to the surface plate, the air pressure was varied progressively up to the maximum air flow (wind pressure) to verify rattling, floating, and variation of a wind noise.

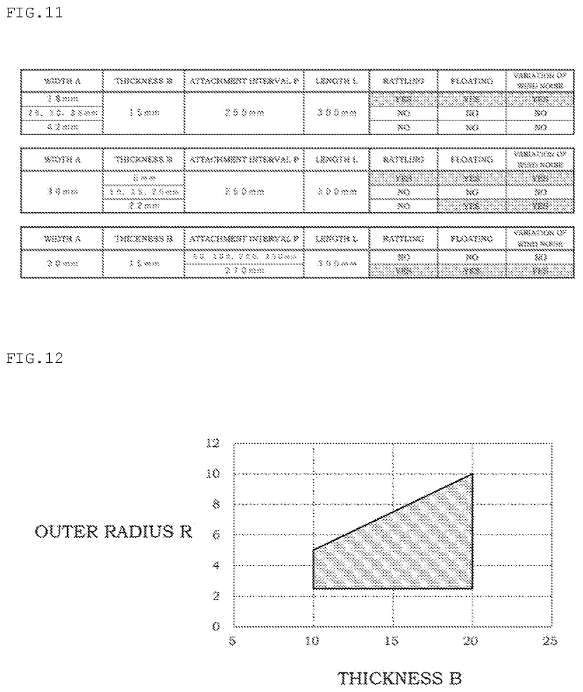

The test results of the wind pressure simulation test conducted under the conditions described above are listed in FIG. 11.

According to the test results, it was observed that when the width A was 20 mm or less or the thickness B was 10 mm or less, the rigidity of the test piece decreased, and rattling or floating occurred when loaded with the wind pressure. Furthermore, it was observed that when the thickness B was 20 mm or more, the test piece floated due to an increased area subjected to the wind pressure and a space was generated between the test piece and the surface plate. Here, it was also observed that the wind noise increased at the same time as the test piece floated. Furthermore, it was observed that when the attachment interval P was 250 mm or more, floating and rattling of the test piece occurred at a position away from the fixing stay 40.

As other constraints on the dimensions, it was observed that when the width A was 20 mm or less, an attachment space for the mohair 60 decreased, which made it difficult to attach the mohair 60. Furthermore, an excessively large width A reduces the area of the net part 2, which affects external appearance. Accordingly, the width A is preferably 50 mm or less. Fixing the fixing stays 40 at multiple positions with the attachment interval P of 50 mm or less is not preferable because external appearance is affected.

From the test results described above, it was observed that sectional dimensions for the rail member 10 that were the most suitable for the embodiment were 20 mm or more and 50 mm or less in the width A and 10 mm or more and 20 mm or less in the thickness B. Furthermore, it was observed that the most suitable attachment interval P for a plurality of fixing stays 40 was 50 mm or more and 250 mm or less.

As described above, according to the window screen for automobile of the present invention, the automobile can be driven with the window screen attached to the outside of the window frame, and floating of the window screen or occurrence of a wind noise can be suppressed even under a wind pressure while the automobile is being driven.

Although the window screen for automobile according to the present invention has been described, as an example, as to when the section of the rail member 10 is formed from, as illustrated in FIG. 2 and FIG. 3, the bottom surface 11, which is a surface that is to face a window frame, the front surface 12, which is a surface that is opposite to the bottom surface 11 and located on the outside in the attached state, the outer side surface 13, which is a surface that connects the bottom surface 11 and the front surface 12 and is located on a circumference of the frame body 1, and the inner side surface 14, which is a surface that connects the bottom surface 11 and the front surface 12 and is located on the inside of the frame body 1, the sectional shape of the rail member 10 is not limited thereto, and may be substantially a D-shape or substantially a half-moon shape in which the shape of the front surface 12 is a large-radius curved surface. Furthermore, the sectional shape may be substantially a trapezoid in which the outer side surface 13 or the inner side surface 14 is inclined. It will be evident from the claims that any modes modified or altered in such a way are to be encompassed in the technical scope of the present invention.

### REFERENCE SIGNS LIST

1: frame body
2: net part
3: pressure rubber
10: rail member
11: bottom surface
12: front surface
13: outer side surface
14: inner side surface
15: first groove portion
15a: rubber pressure piece
15b: protruding part
15c: inward-facing ridge
15d: support piece
16: second groove portion
17: third groove portion
18: outside corner
19: inside corner
20: hollow portion
30: corner member
31: corner part
31a: corner part bottom surface
32: insertion part
40: fixing stay
41: fixture end portion
42: leading end portion
50: attachment member
51: screw
52: spring washer
53: nut
60: mohair
70: sealing and cushioning material
100: window screen
F: window frame
W: window glass
S: space
G: drain gap
K: drain through-portion

1. A window screen for automobile that can be attached outside a window frame of an automobile,
the window screen for automobile comprising a frame body that substantially conforms to the window frame,
the frame body including:
at least one rail member constituting a straight portion;
a corner member coupled to the at least one rail member; and
a fixing stay that is attached to the at least one rail member with an attachment member and that is to be inserted between the window frame and a window glass, wherein
the at least one rail member has a thickness dimension of 10 mm or more and 20 mm or less and a width dimension of 20 mm or more and 50 mm or less, the at least one rail member is provided with a curved surface that has a radius of 2.5 mm or more and 10 mm or less in an outside corner and is provided with a curved surface that has a radius of 0.1 mm or more and 1.5 mm or less in an inside corner, and
the attachment member for attaching the fixing stay is attached in plurality with an interval of 50 mm or more and 250 mm or less on one of the at least one rail member.

2. The window screen for automobile according to claim 1, wherein the rail member located on a bottom is provided with a drain gap.

3. The window screen for automobile according to claim 1, wherein the corner member is provided with a sealing and cushioning material.

4. The window screen for automobile according to claim 1, wherein the at least one rail member is provided with mohair.

5. The window screen for automobile according to claim 1, wherein the fixing stay is divided and arranged in a plurality of fixing stays.

6. The window screen for automobile according to claim 1, wherein a cushioning material is attached to the fixing stay.

7. The window screen for automobile according to claim 1, wherein the fixing stay is provided with a drain through-portion.
